(19) United States
(12) Patent Application Publication
(10) Pub. No.: US 2012/0104877 A1
(43) Pub. Date: May 3, 2012

(54) Portable Linear Generator

(75) Inventor: Blake L. Isaacs, Lees Summit, MO (US)

(73) Assignee: Blake L. Isaacs

(21) Appl. No.: 12/917,617

(22) Filed: Nov. 2, 2010

(51) Int. Cl. H02K 35/02

(52) U.S. Cl. 310/30

(57) ABSTRACT

A portable linear generator for use as a battery charging element inside a portable powered device using multiple permanent magnets arranged linearly with each magnet constrained to repel each nearest magnet, one of the magnets fixed at one or each end of the array, one or more of the magnets free to move along the axis of the array, a guide rod extending through the magnets having a low friction or low friction and diamagnetic surface, and coaxially wound coil or coils of magnet wire arranged to electrically connect outside the device.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of generating electrical energy for portable battery charging and more specifically to a portable kinetic energy to electrical energy conversion device using repelling magnets.

Rare earth permanent magnets have become very common, varied in size and strength, and inexpensive. They are most often used in simple scientific experiments or in applications requiring temporary attachment of papers to magnetic surfaces, or as clasps in handbags or cabinets, or other applications. More recently, these magnets have found use in “shaker” or Faraday flashlights. These devices make use of magnetic induction, human energy, and the new generation of white light emitting diodes that produce much more light from less energy than previous generation LED's.

The suspension of thin wafers of pyrolytic graphite, a strong diamagnetic material, above an arrangement of magnets has become a popular science activity. Pyrolytic graphite is not only diamegnitic, but also has very high planar thermal conductivity and is commonly used as a heat conductor in electronics. It has thus far seen little commercial use for its diamagnetic property due to how small the diamagnetic forces are compared to the force of gravity acting on the mass of permanent magnets or on the mass of objects to which the pyrolytic graphite might be attached.

There are multiple inventions that make use of magnetic induction and human mechanical energy that describe permanent magnets suspended between mechanical springs or free to slide and bounce against fixed surfaces or fixed mounted elastomeric or other spring bumpers and inside a tube such that mechanical oscillation of the magnet due to impacting or shaking the assembly will generate current flow in one or more surrounding conductive coils. These are most commonly used in kinetic charging or shaker flashlights, but could theoretically be used in other applications. While novel and useful for many purposes, these flashlights require significant effort for consumers to charge by shaking or impacting them. These devices have significant internal friction, and they tend to be noisy when shaken.

Other kinetic charging inventions such as piezoelectric element arrays and mechanical pendulum machines are also available, but these have limited application due to size and efficiency limitations and other concerns.

Whereas spring assemblies have mechanical friction and springs exert a force that is linear with respect to distance, magnetic fields exert a frictionless force that is exponential with respect to distance. These properties of magnetic fields can be used to create a relatively quiet oscillation system that provides for longer travel and more oscillations of magnets relative to fixed conductive coils and will thus generate more electrical energy for the same mechanical motion or impulse.

### BRIEF SUMMARY OF THE INVENTION

The primary object of the invention is to provide a portable linear generator or kinetic charging device that generates significant or even sufficient energy from normal motions of a portable powered device into which it is assembled or in which it is carried.

Another object of the invention is to provide a more efficient kinetic charging device with reduced internal friction and multiple charging pulses from a single mechanical impulse.

Another object of the invention is to provide a more quiet kinetic charging device.

A further object of the invention is to provide a low cost and easily manufactured kinetic charging device.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a portable kinetic energy to electrical energy conversion device for use as a battery charging means inside a portable powered device using repelling permanent magnets comprising: a linearly arranged array of axially magnetized permanent ring or cylinder magnets with each magnet constrained to repel each nearest magnet, a magnet at one or both ends of the array fixed to the end or ends of an enclosed housing, one or more magnets unattached and free to move along the axis of the array within the housing, A guide rod having a low friction or low friction and diamagnetic surface and coaxially centered on the axis of the magnet array, and a coaxially wound coil or series of coils of magnet wire available for external electrical connection.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an elevational view of a single magnet and single coil linear generator.

FIG. 2 is a cross sectional view of FIG. 1.

FIG. 3 is an elevational view of a single magnet and multiple coil linear generator with the coils connected in series.

FIG. 4 is an elevational view of a multiple magnet and multiple coil linear generator with each of the coils separately available for external connection.

FIG. 5 is an elevational view of a single magnet and multiple coil linear generator with multiple sets of series connected coils.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The preferred configuration and orientation of the portable linear generator will be selected based on the parameters of the portable powered device into which it will be assembled, including the battery capacity and typical discharge rate, the size of the device, and the most common physical orientations for the device when resting, in use, and being carried.

Recognizing that the magnetic field strength of permanent rare earth magnets is limited by the size and configuration of these magnets, it is possible to scale the linear generator according to the intended application. Larger generators will be capable of generating more electrical energy, but these will be too heavy and/or too large for some applications.

Tipping movements of a horizontally oriented generator will cause the free magnet(s) to slide toward one end of the tube until the repelling force between the free magnet or magnets and the fixed magnet overcomes the combined forces of gravity and friction, stopping the free magnet or magnets and forcing them to move or bounce in the opposite direction along the axis. When the device is next picked up or moved, the end of the device that was lower when the case was previously set down might now be higher, causing the free magnet or magnets to slide toward the other end of the tube, and so on. Each time the free magnet or magnets move through one or more coils, electrical energy pulses will be generated. A vertically oriented assembly would similarly capture the energy associated with picking the device up, setting it down, or other motions that generate vertical acceleration.

In any application, the primary method of generating electrical energy is for normal movements related to carrying the powered device to generate mechanical impulses on the charging coil assembly, causing the free magnet or magnets in the assembly to move through the coil or coils as many times as possible for a given mechanical impulse.

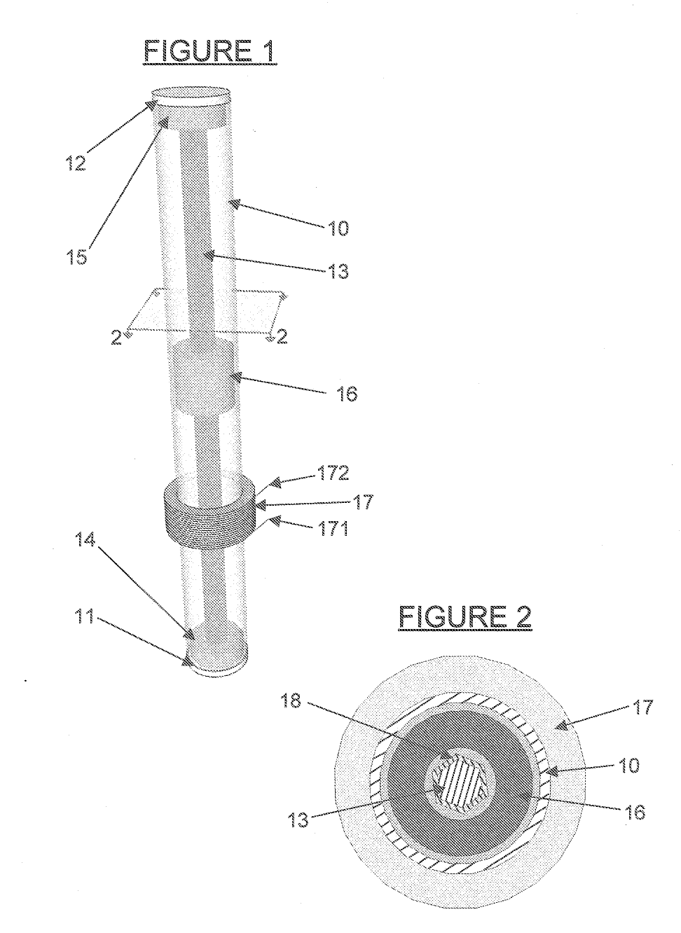

Referring now to FIG. 1, showing a first embodiment of a complete linear generator assembly. The tube 10 is capped at each end by end-caps 11 and 12, each attached to the respective end of tube 10. The housing formed by tube 10 and end-caps 11 and 12 is enclosed and may be made to contain a vacuum. Inside the bottom end of tube 10 a ring magnet 14 is attached to end cap 11, and inside the top end of tube 10, a ring magnet 15 is attached to end cap 12. Ring magnets 14 and 15 are similar and are centered on the axis of the assembly. The free magnet 16 is unattached to any element and is free to slide along the guide rod 13. All magnets 14-16 are axially magnetized. Magnet 16 has approximately the same outside diameter as magnets 14 and 15. Magnet 14 is oriented to repel magnet 16, and magnet 15 is also oriented to repel magnet 16. Rod 13, the alignment means or guide for magnet 16 extends from the bottom end-cap 11 to the top end-cap 12 and is centered along the axis of the assembly. The diameter of rod 13 is slightly less than the inside diameter of magnet 16, and is large enough to constrain the movement of magnet 16 away from the center axis such that magnet 16 cannot touch anything except rod 13. Rod 13 may be comprised of low friction material such as Teflon, or may be comprised of any appropriate material covered symmetrically with narrow sheets of diamagnetic material such as pyrolytic graphite 18 as a means to reduce friction. This is shown in the cross sectional view FIG. 2. The diamagnetic material 18 is used as a means to exert a small repelling force that will tend to keep magnet 16 centered on the axis of the assembly and not touching any element of the assembly when the assembly is vertical or near vertical. When the assembly is not vertical or near vertical, gravity acting on magnet 16 will overcome the force of the pyrolytic graphite 18, letting magnet 16 touch rod 13, and relying on the low friction property of the pyrolytic graphite surface 18 to still allow relatively free movement of magnet 16. The inside diameter of tube 10 is small enough to place the coil 17 close to magnet 16 as is slides through, but large enough not to touch magnet 16. Tube 10 is shown for illustration purposes as translucent, but need not be so. The means of generating current, coil 17, is comprised of many turns of a single strand of fine gauge magnet wire wound as closely as possible to the outer surface of tube 10. The number of turns will vary according to the application. Coil 17 is centered along tube 10 at approximately the center height of magnet 16 when the assembly is at rest and vertical. The axial height of coil 17 is equal to or less than the axial height of magnet 16. The axial height of tube 10 is set to allow free linear travel of magnet 16 along the axis of multiple times the axial height of magnet 16. The ends 171 and 172 of the strand of wire comprising the coil 17 are available for external electrical connection to electrical energy harvesting circuitry that uses well known battery charging techniques.

A lower cost variation of this embodiment would be to eliminate rod 13 from the assembly, relying on the inner wall of tube 10 to constrain and align magnet 16 and to allow for the substitution of cylinder magnets for ring magnets 14-16. In this embodiment, tube 10 would be made of low friction non-conductive material such as Teflon. It will be appreciated by those familiar with the art that there will be more friction between magnet 16 and the restraint tube 10 than there would be between magnet 16 and the restraint rod 13, especially if the surface 18 of rod 13 is comprised of low friction diamagnetic material. Consequently, this alternative embodiment will not perform as well. However, this may be a desired cost-performance tradeoff for some applications.

The linear generator assembly will be fixed within or carried within a powered device. Movement of the powered device will generate acceleration of the assembly in the direction of the assembly axis. This acceleration will oppose gravity or combine with gravity to cause magnet 16 to move along the assembly axis and pass through coil 17. The repelling forces of magnets 14 and 15 will combine with gravity and cause magnet 16 to move in an oscillating fashion. Restriction of the free movement of magnet 16 is minimized to allow it to pass through coil 17 quickly and multiple times. It will be appreciated by those familiar with the art that these oscillations will only be damped by friction within the system, and that since this friction is significantly reduced, especially when the assembly is vertical or near vertical, the oscillations will continue for a significant duration, generating many charging pulses from a single mechanical impulse on the system.

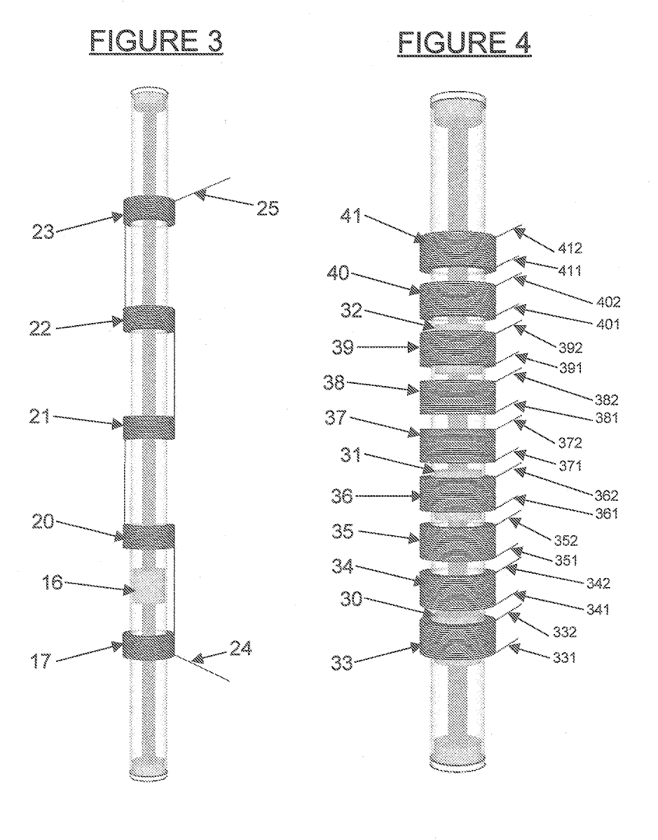

Referring now to FIG. 3, showing a second embodiment of a complete linear generator assembly. This embodiment is similar to the first embodiment, but with added length or axial height and added charging coils 20-23. Five coils are shown as an example, but there could be as few as two coils. These charging coils are electrically connected in series. The two ends 24 and 25 of the strand of wire comprising coils 17, and 20-23 are available for external electrical connection. In this embodiment, the assembly could be any practical length, and the number of coils is limited only to ensuring that the successive coils are separated by approximately twice the axis height of the free magnet 16 or more.

Referring now to FIG. 4, showing a third embodiment of a complete linear generator assembly. This embodiment is similar to the first embodiment, but with three free magnets 30-32 and nine coils 33-41. These magnets are aligned to repel each magnet next in line in each direction. Nine coils are shown as an example, but there could be few as the number of free magnets. Three free magnets are shown as an example, but there could be as few as one, or as many as the number of coils. Each pair of ends 331, 332-411, 412 of the strands of wire comprising each coil 33-41 respectively are made available separately for external electrical connection to battery charging circuitry. In this embodiment, the assembly could be any practical length, and the number of coils is limited only to ensuring that adjacent coils are electrically insulated from each other. It will be appreciated by those skilled in the art that increasing the number of free magnets will increase not only the number of charging pulses generated, but will also increase the frequency of oscillation of the free magnet 30 nearest the lower end of the assembly. This behavior may be advantageous in some applications.

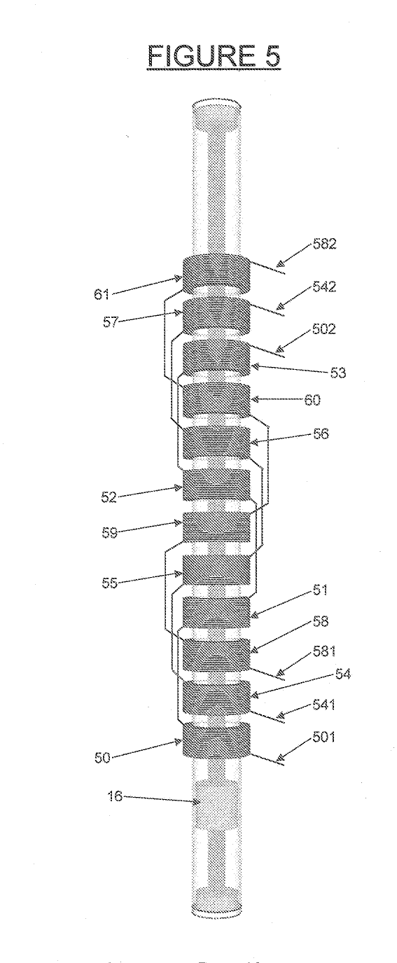

Referring now to FIG. 5, showing a fourth embodiment of a complete linear generator assembly. This embodiment is similar to the first embodiment, but with added length or axial height and multiple charging coils 50-61. Twelve coils are shown as an example, but there could be as few as four coils. Sets of these coils are electrically connected in series such that connected coils are separated along the tube by approximately at least twice the axial length of free magnet 16. In this example there are three sets of coils comprising 4 coils each. The two ends 501 and 502 of the strand of wire comprising coils 50-53 are available for external electrical connection. The two ends 541 and 542 of the strand of wire comprising coils 54-57 are available for separate external electrical connection. The two ends 581 and 582 of the strand of wire comprising coils 58-61 are available for separate external electrical connection. In this embodiment, the assembly could be any practical length, and the number of coils is limited only to ensuring that adjacent coils are electrically insulated from each other.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A portable linear generator for use as a battery charging means inside a portable powered device using a linear arrangement of repelling permanent magnets comprising:
An array of permanent ring or cylinder magnets arranged along a single axis with each magnet constrained to repel each nearest magnet;
A magnet at one or both ends of the array attached to the end or ends of an enclosed housing;
One or more magnets unattached and free to move along the axis of the magnet array within the housing along a guide rod having a low friction or low friction and diamagnetic surface and coaxially centered on the axis of the magnet array; and
A coaxially wound coil or series of coils of magnet wire arranged according to a repelling magnet array.

2. The device of claim 1 wherein the free magnets are able to easily travel along the axis of the tube a distance of approximately the axis height of the free magnet or more.

3. The device of claim 1 wherein each coil assembly is further comprised of a coil of many turns of fine gauge magnet wire wound around the tube such that the width of each coil is less than or approximately the same as the axial height of the free magnet,

4. The device of claim 1 wherein the lower end coil is placed such that it is centered on approximately the equilibrium point of the center of the free magnet within the tube when resting vertically.

5. The device of claim 1 wherein the guide rod of claim 1 may be further comprised of a surface covered with a diamagnetic material such as pyrolytic graphite. This surface may be continuous or may be comprised of multiple strips of the diamagnetic material attached along the length of thes rod such that the perpendicular cross-section of the combination of these strips or of the lines extending from the edges of these strips forms a regular polygon centered on the axis of the rod.

6. The device of claim 1 wherein the enclosed housing may be sealed with a permanent vacuum inside.

7. The device of claim 1 wherein if there is one free magnet and multiple coils, these coils or overlapping sets of coils may be electrically connected in series such that successive series connected coils are separated along the enclosure by approximately twice the axial height of the free magnet or more.

8. The device of claim 1 wherein if there are multiple free magnets, there are at least as many coils as the number of free magnets, each coil being separately available for external electrical connection.
